(19) United States
(12) Patent Application Publication
(10) Pub. No.: US 2025/0074724 A1
(43) Pub. Date: Mar. 6, 2025

(54) EMPTYING DEVICE FOR EMPTYING A CONTAINER

(71) Applicant: HECHT Technologie GmbH, Pfaffenhofen/Ilm (DE)

(72) Inventor: Thomas SCHWAIGER, Pfaffenhofen/Ilm (DE)

(21) Appl. No.: 18/817,764

(22) Filed: Aug. 28, 2024

(30) Foreign Application Priority Data
Aug. 30, 2023 (DE) 10 2023 123 337.8
Sep. 26, 2023 (DE) 10 2023 126 027.8

(51) Int. Cl. B65G 65/36; B65G 69/18

(52) U.S. Cl. CPC B65G 65/36; B65G 69/181; B65G 2201/042

(57) ABSTRACT

The application relates to an emptying device for emptying a container containing a product, including: a docking portion for docking to a rigid container to be emptied, in particular a drum, wherein in the docking portion a passage is formed by an adjustable sealing device, wherein the passage can be adjusted via the sealing device in such a way that an adapter piece being fixed to a flexible container enclosing the product, in particular a liner or a film bag, inside the rigid container, can be fastened within the passage in such a way that an enclosed inner space defined by the docking portion and the rigid container is sealed off from an external environment.

This application claims priority to German Patent Application 10 2023 123 337.8 filed Aug. 30, 2023 and German Patent Application 10 2023 126 027.8 filed Sep. 26, 2023, the entire disclosure of which is incorporated by reference herein.

The present invention relates to an emptying device for emptying a container containing a product, an adapter piece and a method for docking an emptying device to a corresponding container.

Powder or granular products, generally bulk goods, are usually filled into drums by manufacturing companies for storage and transportation. In addition, many branches of industry, especially the food and pharmaceutical industries, place high purity requirements on the bulk goods contained in the drums and the bulk goods often pose a health risk to persons processing the bulk goods due to their toxicity. For these reasons, protective measures must be taken when emptying such drums.

On the one hand, the bulk material in the drum is enclosed by one or more flexible casings (so-called film bags/liners) to protect the bulk material and the people processing it. This means that the drum can at least be opened safely by the person handling the drum.

On the other hand, special devices are used when emptying such drums to ensure that neither the bulk material is contaminated by contact with the environment nor a person emptying the drum is contaminated by the bulk material.

Such a device is shown, for example, in DE 10 2014 200 452 A1. The device comprises an isolator to which a drum to be emptied may be connected and which defines a space sealed off from an external environment. After connecting the drum, the processing person can reach into the enclosed space via glove ports and open the film bag/liner surrounding the bulk material without risk of contamination inside the isolator.

To empty the film bag/liner, the person can then insert a conveyor line provided at least partially inside the isolator into the opened film bag/liner and remove or extract the bulk material via a pneumatic conveyor.

However, a number of problems arise in connection with the configuration and procedure described above, which are explained below.

Connecting the drum to the isolator involves a large number of manual operations and therefore takes a considerable amount of time. Furthermore, the isolator increases the dimensions of the emptying device and has to meet high requirements with regard to tightness to prevent material from escaping. In addition, cleaning the isolator also involves a considerable amount of effort, which means that changing the product to be emptied requires a considerable amount of time for cleaning.

Against this background, it is an object of the present invention to create an emptying system without an isolator which also provides simpler and faster handling compared to the state of the art.

This object is solved with an emptying device according to patent claim 1, an adapter piece according to patent claim 8 and a method for emptying according to patent claim 15. Preferred embodiments are subject-matters of the dependent claims.

An emptying according to the invention for emptying a container containing a granular product comprises:
a docking portion for docking to a rigid container to be emptied, in particular a drum, wherein in the docking portion a passage is formed by an adjustable sealing device, wherein
the passage can be adjusted via the sealing device in such a way that an adapter piece being fixed to a flexible container enclosing the product, in particular a liner or a film bag, inside the rigid container, can be fastened within the passage in such a way that an enclosed inner space defined by the docking portion and the rigid container is sealed off from an external environment.

The emptying device according to the invention is used in particular to empty containers containing a powdery and/or granular product which, for example, constitutes a potential hazard to a user, would potentially contaminate the environment and/or has a degree of purity which must be maintained.

In particular, the enclosed inner space is preferably defined by an inner wall of the rigid container, a surface of the docking portion facing the interior of the rigid container and the adapter piece.

The sealing device is preferably formed by an inflatable seal surrounding the passage.

In particular, the sealing device preferably comprises a flexible sealing element formed by an inflatable seal. The inflatable seal is preferably torus-shaped formed of an elastic material. Furthermore, the inflatable seal is preferably connected to a compressed air supply so that the air pressure within the inflatable seal can be increased. Moreover, an adjustment device, in particular a valve, is preferably provided via which the air pressure within the inflatable seal can be adjusted. When the air pressure is increased, the inflatable seal preferably expands, so that the expansion of the inflatable seal increases and it is pressed against the adapter piece, whereas it preferably relaxes when the air pressure is reduced, so that the expansion of the inflatable seal decreases. In other words, the passage defined by the docking portion in this way can be adjusted via the sealing device.

Preferably, a suction device is provided to the docking portion, being configured to lower an ambient pressure within the enclosed inner space in such a way that the flexible container abuts against an inner wall of the rigid container at least partially.

By lowering the air pressure inside the enclosed inner space, a flexible outer skin of the flexible container is preferably attracted to the inner wall of the rigid container. This fixes the flexible outer skin of the flexible container and prevents the user from being hindered by the flexible container when removing the product. This improves the handling of the emptying device in particular.

Preferably, the emptying device further comprises a conveyor line being insertable through the passage of the docking portion and through the adapter piece into the flexible container enclosing the product in order to remove the product.

Preferably, the flexible container enclosing the product is open in the region of the passage during insertion, so that the product is accessible.

Preferably, the docking portion comprises a rigid plate attachable to an opening of the rigid container flexible connecting member and a passage portion forming the passage and supporting the sealing device, wherein
the rigid plate and the passage portion are connected via the flexible connecting element in such a way that deviations in a distance and/or a relative positioning between the passage portion forming the passage and the adapter piece fixed to the flexible container can be compensated for during fastening by deformation of the flexible connecting element.

Due to the flexible outer skin of the flexible container enclosing the product, there are deviations in the surface of the flexible container intended for fixing the adapter piece. In addition, there are also deviations due to the individual positioning of the adapter piece due to manual attachment by the user. These deviations can be compensated by the flexible connecting element.

Moreover, forces that act on the sealing device and/or the connecting portion during emptying can preferably also be absorbed by the flexible connecting element.

Preferably, the rigid plate forms a further passage to which a further adjustable sealing device is provided, wherein
the further passage can be adjusted via the further sealing device in such a way that the flexible connecting element can be fastened within the further passage for connection to the rigid plate.

This allows the flexible connecting element to be removed from the further passage formed by the rigid plate. This increases the modularity of the emptying device and is particularly advantageous in connection with cleaning the emptying device. In particular, various connecting elements can be inserted into the passage of the rigid plate. Moreover, the possibility of removing the flexible connecting element is particularly advantageous in connection with cleaning aspects.

Preferably, the further sealing device also comprises a flexible sealing element formed by an inflatable seal. The inflatable seal is preferably torus-shaped formed of an elastic material. Furthermore, the inflatable seal is preferably connected to the compressed air supply so that the air pressure inside the inflatable seal can be increased. Moreover, an adjustment device, in particular a valve, is preferably provided via which the air pressure within the inflatable seal can be adjusted. When the air pressure is increased, the inflatable seal preferably expands, so that the expansion of the inflatable seal increases and it is pressed against the flexible connecting element, wherein when the air pressure is reduced, it preferably relaxes, so that the expansion of the inflatable seal decreases. In other words, the further passage defined by the rigid plate in this way can be adjusted via the further sealing device.

Preferably, the emptying device has a holding frame, wherein
a movement device is provided to the holding frame, being configured to move the docking portion along a longitudinal axis of the rigid container relative to the rigid container in such a way that the docking portion is in an open state or a docked state.

Preferably, the holding frame is further configured to hold the rigid container during emptying.

Further preferred features of the emptying device according to the invention are described in the context of the embodiment.

An adapter piece according to the invention for attachment to a flexible container enclosing a product, comprising:
a fixing portion being fixable to a flexible container enclosing the product, in particular a liner or a film bag, and
a sealing portion being configured to interact with an adjustable sealing device of a docking portion of an emptying device in such a way that an enclosed/sealed connection between the sealing portion and the sealing device can be established.

Preferably, the adapter piece further comprises an adhesive layer to be fixed to an outer surface of the flexible container.

The adhesive layer can be any type, for example a pressure-sensitive adhesive, a thermal adhesive or an adhesive that is cured by UV radiation.

The adhesive layer is preferably used to fix the adapter piece to the flexible container.

Preferably, the adhesive layer is formed on a sealing film attached to the fixing portion projecting radially outwards beyond the fixing portion.

The protruding portion of the sealing film preferably improves the adhesion/attachment of the adapter piece to the outer surface of the flexible container because it can flexibly adapt to folds and curvatures of the flexible outer surface.

Preferably, the adapter piece comprises a cutting portion being configured to cut open the flexible container at least partially in order to make an interior of the flexible container accessible for removing the product.

Partial cutting/opening preferably has the advantage that the cut part remains on the flexible container.

Preferably, the fixing portion defines a passage being dimensioned such that the cutting portion can be inserted into the passage of the fixing portion and is guided within the passage.

Preferably, the fixing portion and the cutting portion are ring-shaped. Preferably, the fixing portion and the cutting portion are guided coaxially to each other. Preferably, an inner diameter of the passage of the fixing portion is equal to or slightly larger than an outer diameter of the cutting portion, so that the cutting portion is guided in a sliding manner within the fixing portion. Furthermore, due to the guide within the fixing portion, the cutting portion is preferably movable relative to the fixing portion in such a way that the cutting portion can be pushed into the flexible container for cutting.

Preferably, the sealing film completely spans the passage defined by the fixing portion and is cut through together with the flexible container.

Preferably, a tubular film is fixed to the adapter piece, which can be guided over a conveying line being insertable through the adapter piece into the flexible container containing the product in order to remove the product and can be attached to a support portion formed on the conveyor line.

In a state attached to the support portion, the tubular film preferably forms, together with the remaining adapter piece, a receiving space sealed off from the external environment, in which the conveyor line is accommodated at least partially. In this way, any product stirred up during emptying remains inside the receiving space and cannot escape to the external environment. By forming the receiving space in the interaction of the conveyor line, the adapter piece and the tubular film, it is therefore not necessary to provide an insulator.

Preferably, the tubular film is attached to the support porting using a force-fit. The tubular film is preferably clamped via an O-ring in a circumferential groove formed on the support portion.

Further preferred features of the emptying device according to the invention are described in the context of the embodiment.

The emptying system according to the invention for emptying a container containing a product comprises the emptying device according to the invention and the adapter piece according to the invention.

The method according to the invention for docking an emptying device to a container containing a product comprises the following steps:
Inserting an adapter piece into an interior of a rigid container containing a product to be emptied, in particular a drum;
Fixing the adapter piece to a flexible container enclosing the product, in particular a liner or a film bag, within the interior of the rigid container,
Docking a docking portion to the rigid container to be emptied, wherein a passage with an adjustable sealing device is formed in the docking portion, and
Adjusting the sealing device in such a way that the adapter piece can be fixed within the passage in such a way that an enclosed inner space defined by the docking portion and the rigid container is sealed off from an external environment.

Below, a preferred embodiment of the emptying device according to the invention is explained with reference to the attached Figures.

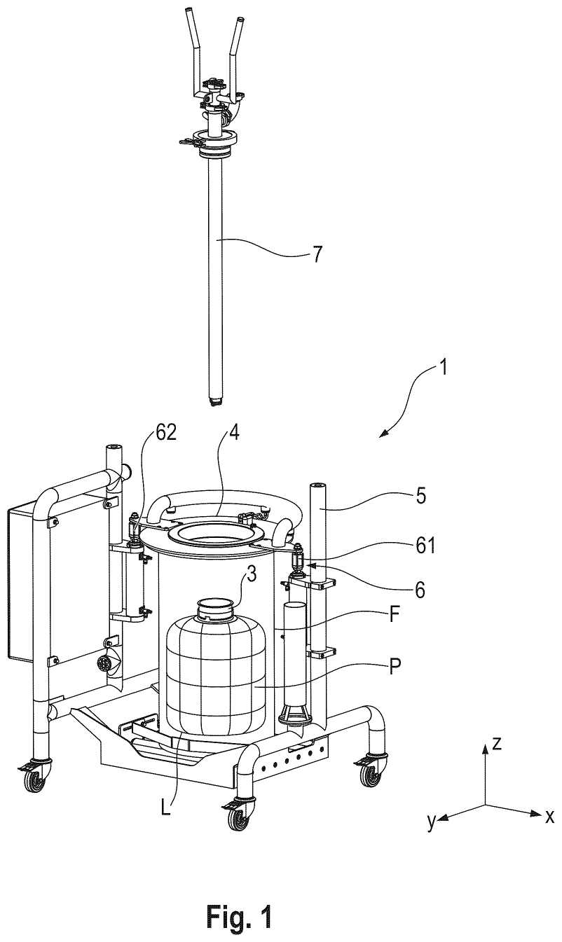

FIG. 1 shows a perspective view of an emptying system according to the invention.

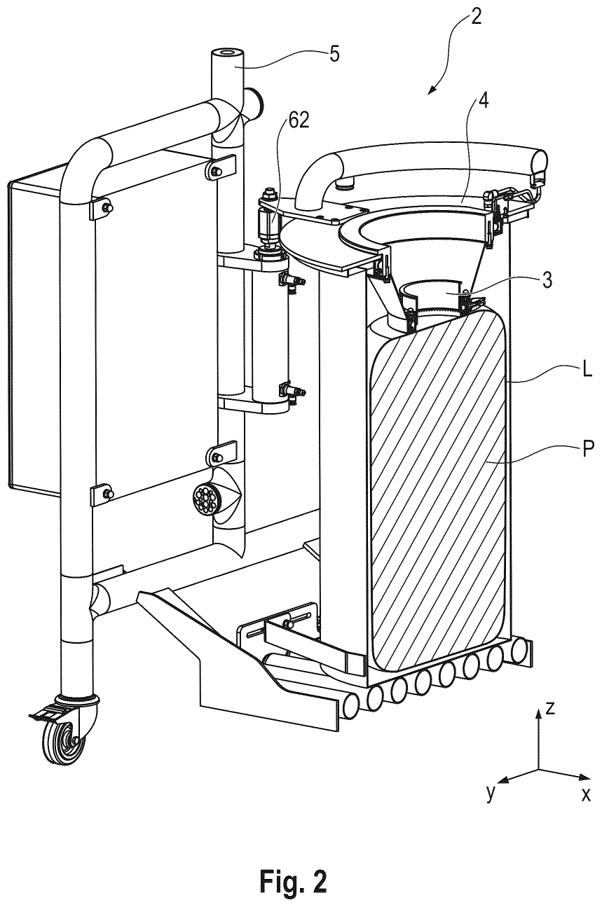

FIG. 2 shows a sectional view of the emptying system according to the invention shown in FIG. 1.

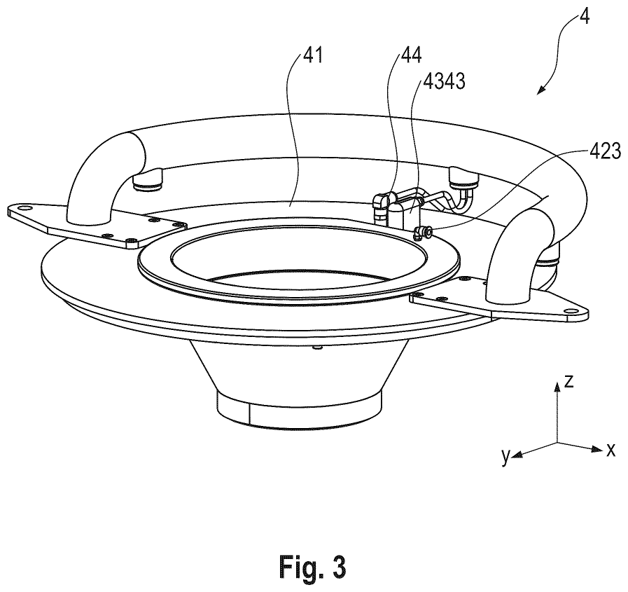

FIG. 3 shows a perspective view of a docking portion according to the invention;

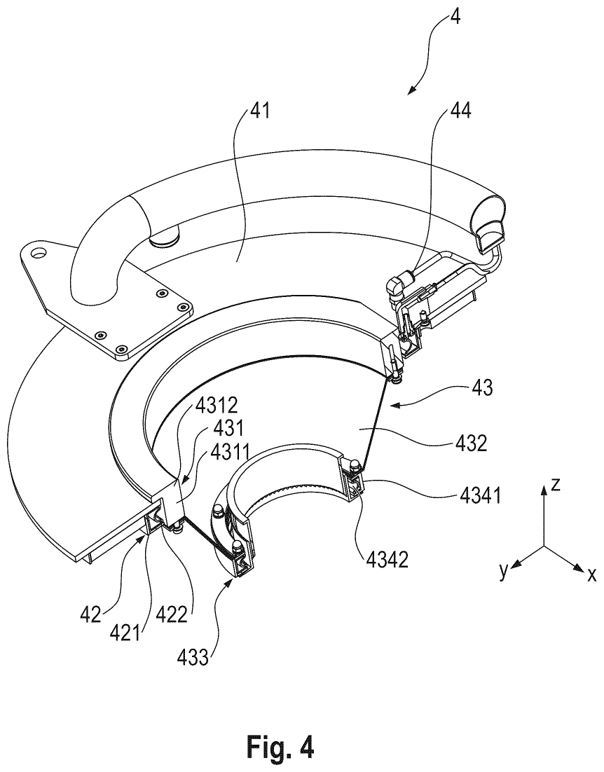

FIG. 4 shows a sectional view of the docking portion according to the invention from FIG. 3.

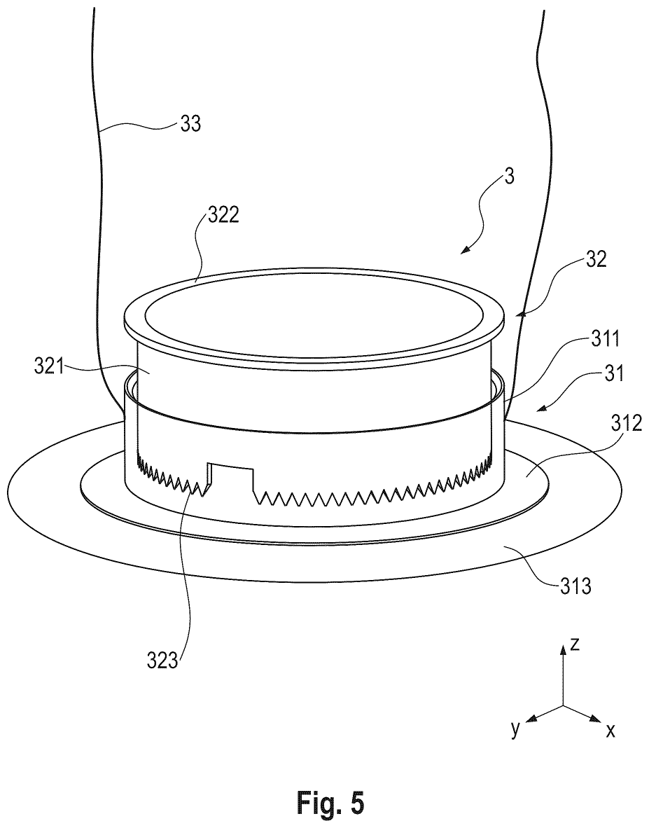

FIG. 5 shows a perspective view of an adapter piece according to the invention;

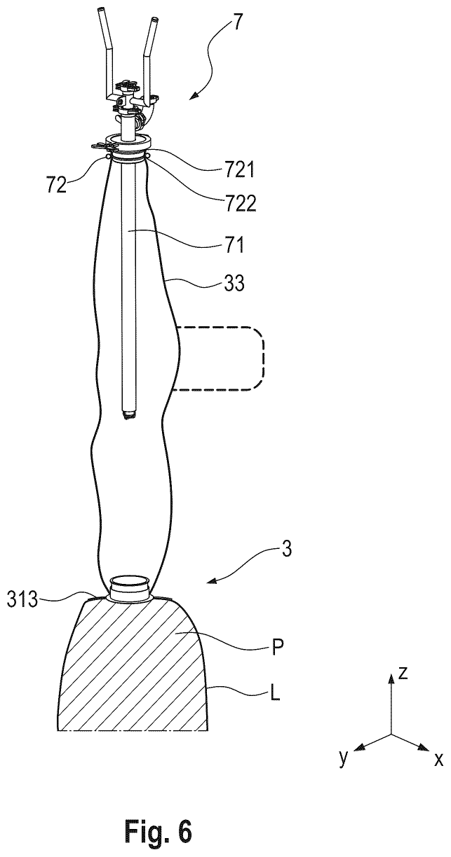

FIG. 6 shows a perspective view in which the tubular film of the adapter piece according to the invention is attached to the conveyor line of the emptying device according to the invention as an example.

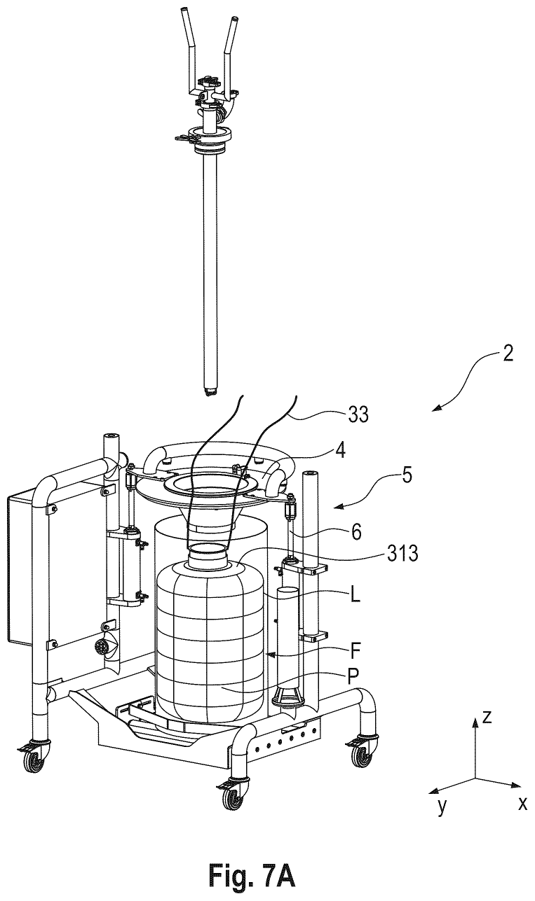

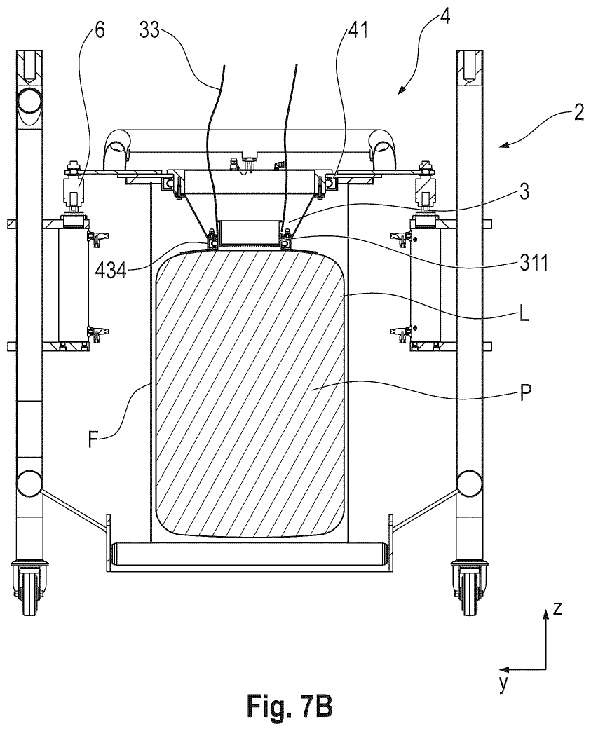

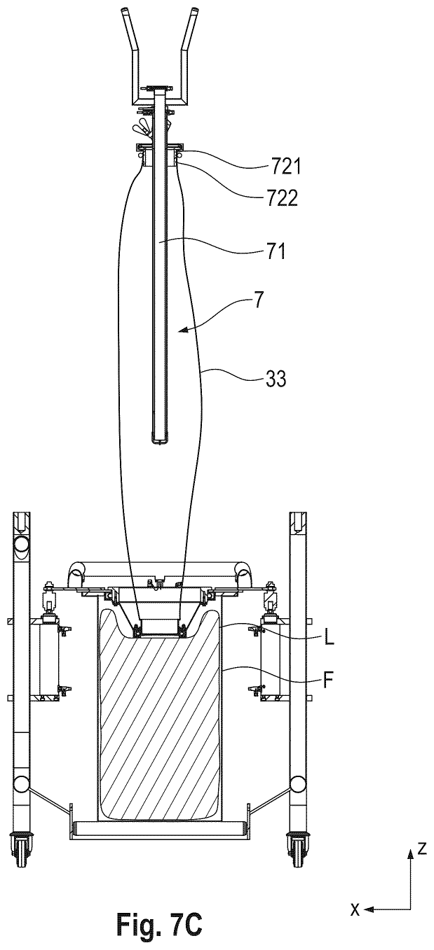

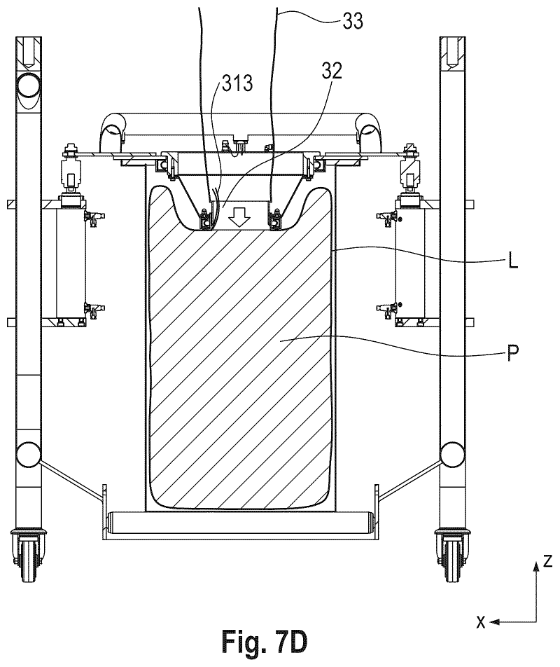

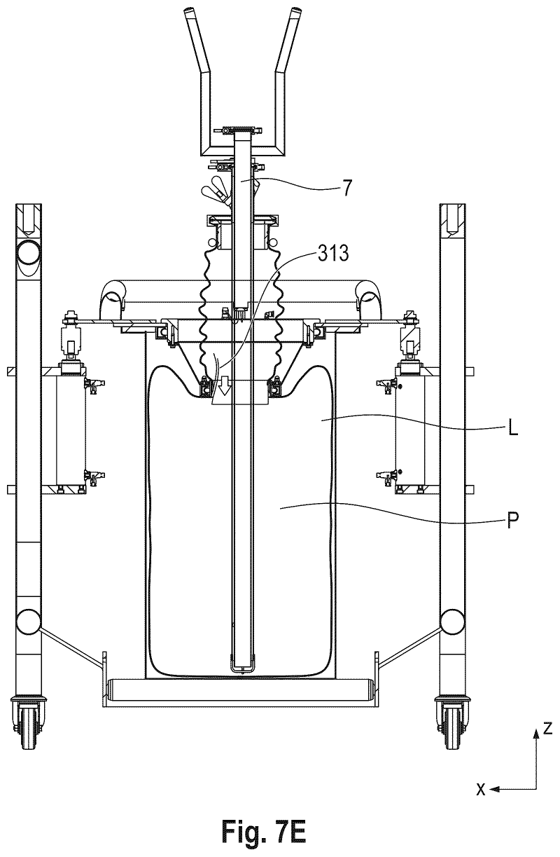

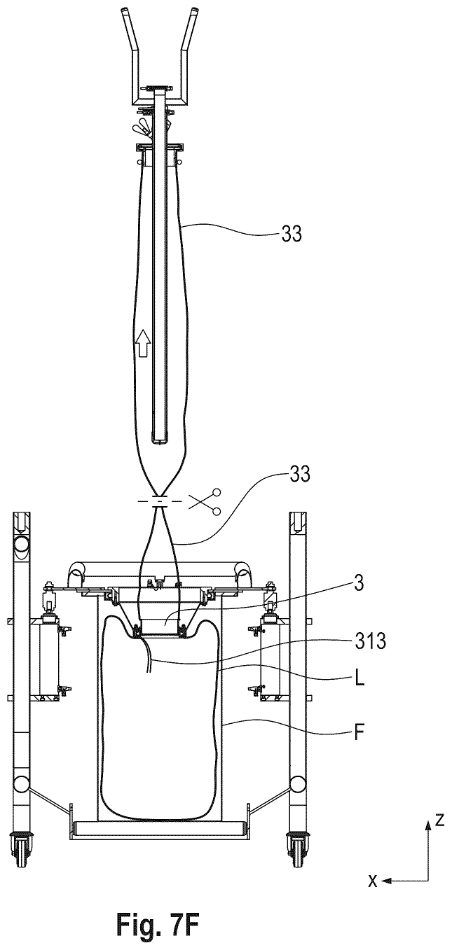

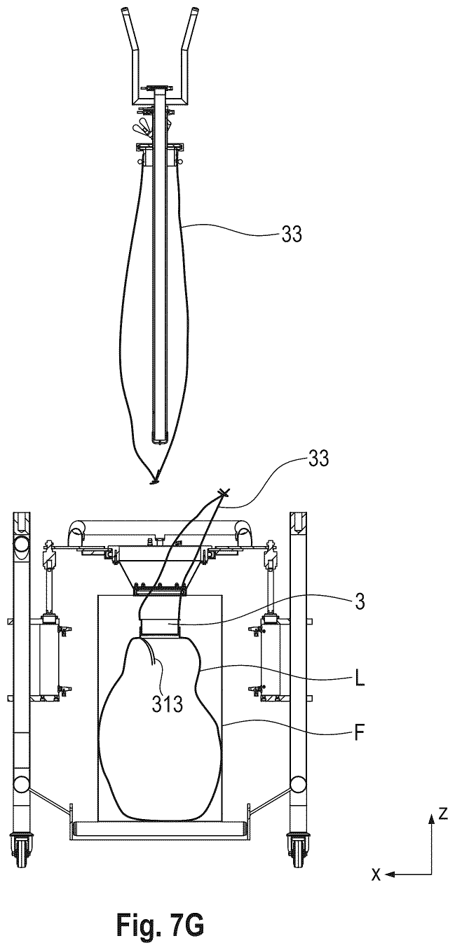

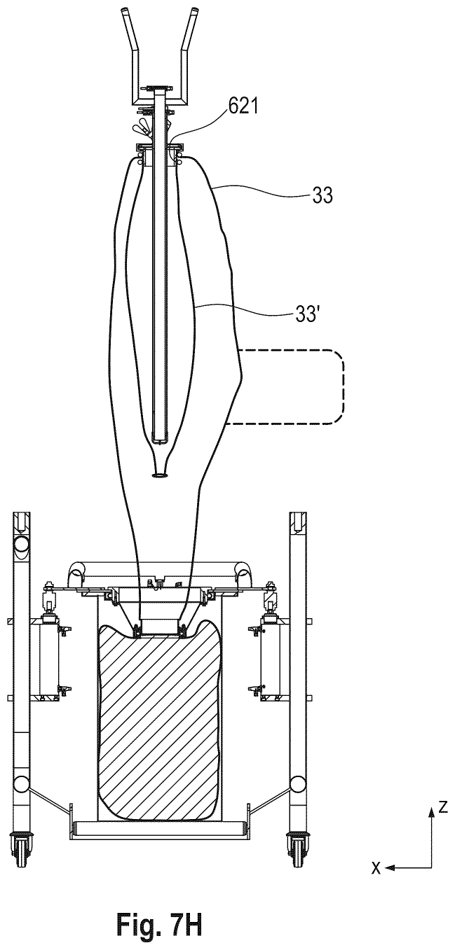

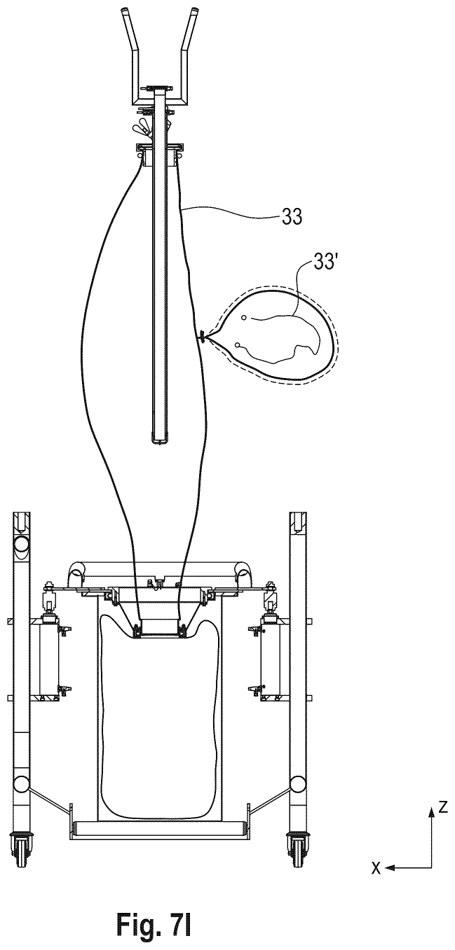

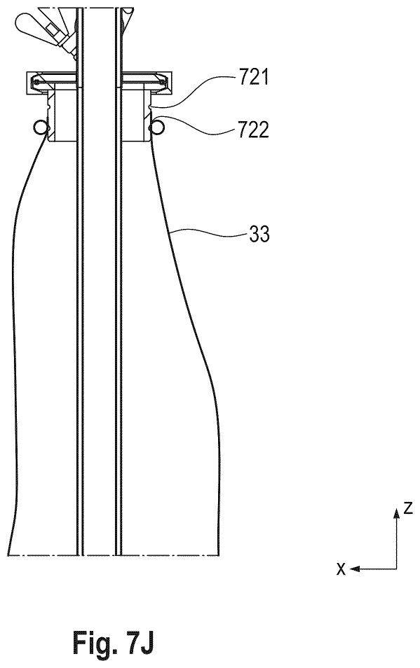

FIGS. 7A to J show the intended method for docking the emptying device according to the invention to a drum containing the product using the adapter piece according to the invention.

FIG. 1 shows a perspective view of an emptying system 1 according to the invention. The emptying system 1 is intended in particular for emptying a rigid container, for example a drum F, containing a product P. The drum F is shown transparent in FIG. 1 so that its content is visible.

The product P contained in the drum F is in particular a powder or granular bulk material. The product P is enclosed inside the drum F by one or more flexible wrappings, so-called film bags/liners L.

The emptying system 1 according to the invention is preferably configured to remove the product P contained in the drum F from the drum F.

The Z-direction shown in FIG. 1 corresponds to a height direction of the emptying system 1, the X-direction shown in FIG. 1 corresponds to a width direction of the emptying system 1 and the Y-direction shown in FIG. 1 corresponds to a depth direction of the emptying system 1.

FIG. 2 shows a sectional view of the emptying system 1 according to the invention from FIG. 1, wherein the section was made at approximately half the width of the emptying device 2 in the width direction X. Consequently, the view shown in FIG. 2 corresponds to the Y-Z plane.

The emptying system 1 comprises an emptying device 2 and an adapter piece 3.

The emptying device 2 comprises a docking portion 4, a holding frame 5, a movement device 6 and a conveyor line 7, which is only shown in FIG. 1.

Preferably, the emptying device 2 according to the invention is placed at a desired location. In this respect, the holding frame 5 preferably has rollers.

In the embodiment shown in FIG. 1, the holding frame 5 is essentially formed by tubes or hollow profiles made of mild steel or stainless steel. The holding frame 5 preferably also accommodates the drum F to be emptied and preferably comprises corresponding means for positioning and fixing the drum F. The means for positioning and fixing preferably enable the drum F to be positioned and fixed as intended, in particular in the width direction X and depth direction Y.

The docking portion 4, which is explained in detail below, can preferably be moved along a longitudinal axis of the drum F relative to the drum F via the movement device 6 in such a way that it is in an open state or a docked state. FIGS. 1 and 2 illustrate the docked state. The open state is preferably a state in which the docking portion 4 is displaced upwards by the movement device 6 and therefore does not rest on the drum F. In the open state, the drum F can preferably be removed from the holding frame 5 after emptying and a new drum F to be emptied can then be inserted/received.

The movement device 6 preferably comprises two pneumatic cylinders 61 respectively 62. These pneumatic cylinders 61 and 62 are preferably connected to a compressed air connector and can be controlled via a control device not shown.

The movement device is not limited to the number of two pneumatic cylinders. Alternatively, several, for example three or four, pneumatic cylinders or just one pneumatic cylinder may be provided.

A first end of each of the pneumatic cylinders 61 or 62 is preferably attached to the holding frame 5 via fastening means. The other end is preferably connected to the docking portion 4. The docking portion 4 can also preferably be mounted to the holding frame 5 such that it can be moved linearly along the longitudinal axis of the drum F.

In the embodiment shown, the pneumatic cylinders 61 and 62 are preferably extended by supplying air via the compressed air connector, thus moving the docking portion 4 to the open state. When the air is removed, however, the pneumatic cylinders 61 and 62 retract and the docking portion 4 is moved back to the docked state.

FIG. 3 shows a perspective view of the docking portion 4.

The docking portion 4 preferably comprises a rigid plate 41, which can be attached to an opening of the drum F. In particular, the rigid plate 41 can be placed/pressed onto an upper rim of the drum F to be emptied in a sealing manner by the movement device 6. In this respect, a suitable sealant, in particular a sealing lip or, in the specific case shown, a foam plate, is preferably provided to the rigid plate 41.

In the embodiment shown, the rigid plate 41 is circular in shape and has an equally circular opening in the center. In other words, the rigid plate 41 is ring-shaped.

FIG. 4 shows a sectional view of the docking portion 4 according to the invention from FIG. 3, wherein the section was made at approximately half the width of the rigid plate 41 in the width direction X. Consequently, the view shown in FIG. 4 also corresponds to the Y-Z plane.

As shown in FIG. 4, the docking portion 4 preferably comprises a first sealing device 42. In the present embodiment, the first sealing device 42 is preferably formed by a sealing ring 421.

The sealing ring 421 is preferably attached to a lower side of the rigid plate 41 facing the drum F, projecting into an interior of the drum F, and surrounds an inner contour of the opening of the rigid plate 41. Alternatively, the sealing ring 421 can also be inserted inside the opening of the rigid plate 41 so that it reduces the diameter of the opening.

An adjustable sealing element 422 is preferably arranged within the sealing ring 421. In the embodiment shown, the adjustable sealing element 422 is preferably formed by a toroidal inflatable seal.

Furthermore, the first sealing device 42 comprises a pump connector 423 (see FIG. 3), via which air can enter or exit the inflatable seal. In this respect, the pump connector 423 is preferably also connected to the compressed air supply, so that the air pressure within the inflatable seal can be increased. In addition, the first sealing device 42 comprises an adjustment device, not shown, by means of which the air pressure within the inflatable seal can be adjusted. When the air pressure is increased, the inflatable seal preferably expands, so that the expansion of the inflatable seal increases, whereas when the air pressure is reduced, it preferably relaxes, so that the expansion of the inflatable seal decreases. In other words, the opening forming the passage can be adjusted in this way via the first sealing device 42. The first sealing device 42 is an example of the further sealing device according to the invention. The first sealing device 42 is an optional component of the docking portion 4.

Furthermore, the docking portion 4 preferably comprises a flexible connecting element 43. The flexible connecting element 43 is preferably insertable into the opening of the rigid plate 41 starting from an upper side of the rigid plate 41 facing away from the interior of the drum F and preferably comprises an insertion portion 431, a flexible connecting portion 432 and a passage portion 433.

The insertion portion 431 is preferably insertable into the opening of the rigid plate 41. Preferably, the insertion portion 431 comprises a ring-shaped portion 4311, which can be inserted into the opening of the rigid plate 41 in a sliding manner in the direction facing the barrel F and, in an inserted state, adjoins the first sealing device 42 at least partially. Furthermore, the insertion portion 431 preferably comprises a flange 4312 on a side facing away from the drum F as intended, which projects radially with respect to the ring-shaped portion 4311 or the opening of the rigid plate 41 in such a way that a surface of the flange 4312 facing the upper side of the rigid plate 41 and the upper side of the rigid plate 41 overlap at least partially. In this way, the flange 4312 rests on the upper side of the rigid plate 41 in the inserted state and holds the insertion portion 431 respectively the flexible connecting element 43 in position. By increasing the air pressure within the inflatable seal of the first sealing device 42, it expands and is pressed against the adjacent ring-shaped portion 4311. In this way, a sealing connection can be created between the rigid plate 41 and the flexible connecting element 43. When the air pressure inside the inflatable seal is reduced, it relaxes and the flexible connecting element 43 can be removed from the opening of the rigid plate 41. In this way, various connecting elements 43 can be inserted into the opening of the rigid plate 41, so that increased modularity is provided. Moreover, the possibility of removing the flexible connecting element is particularly advantageous in connection with cleaning aspects.

The flexible connecting portion 432 is preferably attached/received on the side of the insertion portion 431 facing the drum F. The flexible connecting portion 432 preferably is formed of a flexible plastic, in particular a product of high elasticity produced by vulcanization of natural or synthetic rubber, and is preferably formed in the form of a connecting tube (sleeve) or a bellows. The flexible connecting portion 432 further preferably has the shape of a conical ring and tapers from the insertion portion 431 in a direction facing a bottom of the drum F. In other words, a diameter at an upper end of the flexible connecting portion 432 facing the insertion portion 431 is larger than a diameter at a lower end of the flexible connecting portion 432 facing the bottom of the drum F. The flexible connecting portion 432 is an optional component of the connecting element 43. Alternatively, the connecting element 43 can also be formed without the flexible connecting portion 432 in the form of a rigid element.

At the lower end of the flexible connecting portion 432 facing the bottom of the drum F, the passage portion 433 is attached/received, which defines a passage into the interior of the drum F. The passage portion 433 comprises a second sealing device 434. In the present embodiment, the second sealing device 434 is preferably formed by a sealing ring 4341.

The sealing ring 4341 preferably surrounds an inner contour of the lower end of the flexible connecting portion 432.

An adjustable sealing element 4342 is preferably arranged within the sealing ring 4341. In the embodiment shown, the adjustable sealing element 4342 is preferably formed by a toroidal inflatable seal.

Furthermore, the second sealing device 434 comprises a pump connector 4343 shown in FIG. 3, via which air can enter or exit the inflatable seal. In this respect, the pump connector 4343 is preferably connected to the compressed air supply so that the air pressure inside the inflatable seal may be increased. In addition, the second sealing device 4341 comprises an adjustment device, not shown, by means of which the air pressure within the inflatable seal can be adjusted. When the air pressure is increased, the inflatable seal preferably expands, so that the expansion of the inflatable seal increases, whereas when the air pressure is reduced, it preferably relaxes, so that the expansion of the inflatable seal decreases. In other words, the passage defined by the passage portion 433 in this way can be adjusted via the second sealing device 434. The second sealing device 434 is an example of the sealing device according to the invention.

By increasing the air pressure inside the inflatable seal of the second sealing device 434, it expands and is pressed against the adjacent adapter piece 3. In this way, a sealing connection can be created between the docking portion 4 in the docked state and the adapter piece 3. Thus, the interaction of the docking portion 4 with the adapter piece 3 can form a sealed-off inner space within the drum F.

When the air pressure inside the inflatable seal is reduced, it relaxes and the docking portion 4 can be detached from the adapter piece 3. As a result, the docking portion 4 can be moved from the docked state to the open state by the movement device 6.

Alternatively, the connecting element 43 or only the second sealing device 434 can also be provided directly on/integral with the rigid plate 41. In particular, the sealing ring 4341 can preferably be attached to a lower side of the rigid plate 41 facing the drum F, projecting into an interior of the drum F and surrounding an inner contour of the opening of the rigid plate 41. Furthermore, the sealing ring 4341 can also be inserted inside the opening of the rigid plate 41 so that it reduces the diameter of the opening. In other words, the sealing device according to the invention in the case explained above can be formed analogously to the first sealing device 42, wherein an opening in the rigid plate 41 and an extension of the adjustable sealing element 4342 are such that the sealing connection with the adapter piece 3 can be produced.

Furthermore, the docking portion 4 preferably also comprises a pump connector 44, which preferably penetrates the rigid plate 41 and is configured to reduce the air pressure within an enclosed interior space defined by the docking portion 4 and the adapter piece 3 within the drum F.

By lowering the air pressure inside the enclosed inner space, the flexible outer skin of the foil bag/liner L is preferably attracted to an inner wall of the drum F. In this way, the flexible outer skin of the film bag/liner L is fixed in place and the user is prevented from being hindered by the loose film bag/liner L when removing the product P. In particular, this improves the handling of the emptying device 2 or emptying system according to the invention.

The pump connector 44 is an example of the suction device according to the invention.

The adapter piece 3 according to the invention is explained in detail below. FIG. 5 shows a perspective view of the adapter piece 3 according to the invention.

The adapter piece 3 is preferably to be handled manually by a user and is used as intended to open the film bag/liner L containing the product P in order to be able to remove the product P.

The adapter piece 3 preferably comprises a fixing portion 31, a cutting portion 32 and a tubular film 33. The fixing portion 31 is shown transparent in FIG. 5.

When the adapter piece 3 is used as intended, the fixing portion 31 is fixed to the film bag/liner L enclosing the product P being contained in the drum F.

In this respect, the fixing portion 31 comprises a ring-shaped connecting element 311, a flange portion 312 and a sealing film 313.

The ring-shaped connecting element 311 defines a passage which is dimensioned such that the cutting portion 32 can be inserted into the ring-shaped connecting element 311 in the direction of an axis or passage axis.

The flange portion 312 extends radially outwards from the side of the ring-shaped connecting element 311 facing the film bag/liner Las intended with respect to the passage axis of the passage. The flange portion 312 is pressed against the outer surface of the film bag/liner L by the user when the adapter piece 3 is attached and secured there.

The sealing film 313 is attached to the ring-shaped connecting element 311 and/or the flange portion 312 on the side facing the film bag/liner L as intended. The sealing foil 313 is, for example, firmly welded and/or bonded to the ring-shaped connecting element 311 and/or the flange portion 312.

The sealing film 313 is preferably formed and attached in such a way that it completely spans the passage of the ring-shaped connecting element 311 on the side facing the film bag/liner L as intended. In other words, the passage on the side facing the film bag/liner L as intended is completely closed by the sealing film 313.

Furthermore, the sealing film 313 is preferably formed in such a way that it can serve as a fastening means for connecting the adapter piece 3 to the outer surface of the film bag/liner L. For this purpose, an adhesive or adhesive layer is preferably formed on the side facing the film bag/liner L as intended being configured to adhere to the outer surface of the film bag/liner L in such a way that the sealing film 313 adheres completely or at least partially to the outer surface and thus the adapter piece 3 according to the invention is attached to the outer surface of the film bag/liner L. The invention is not limited to any particular type of adhesive. For example, the adhesive layer can be one that is protected by a protective film to prevent the adhesive layer from hardening prematurely. The user can remove this protective film from the sealing film 313 shortly before attaching the adapter piece 3 and then press the sealing film 313 against the outer surface of the film bag/liner L, to which the adhesive subsequently adheres and preferably hardens quickly in order to attach the adapter piece 3 to the outer surface of the film bag/liner L. Possible adhesives include pressure-sensitive adhesives, such as those used for adhesive tapes, thermal adhesives, which cure by irradiation with a radiant heater, or UV adhesives, which cure by irradiation with UV light.

The sealing film 313 has a thickness in the order of magnitude of available adhesive tapes and is larger in area than the ring-shaped connecting element 311 and/or the flange portion 312. In particular, the sealing film 313 has a projecting portion extending radially outwards from the ring-shaped connecting element 311 or the flange portion 312 with respect to the passage axis.

The projecting portion is formed over the entire circumference of the ring-shaped connecting element 311 or the flange portion 312. Preferably, the projecting portion is constant over the entire circumference, i.e. the distance between the circumference of the sealing film 313 respectively the projecting portion and the circumference of the ring-shaped connecting element 311 respectively the flange portion 312 is constant over the entire circumference.

The protruding portion of the sealing film 313 ensures improved adhesion/attachment of the adapter piece 3 to the outer surface of the film bag/liner L, because it adapts flexibly to folds and curvatures of the flexible outer surface.

Preferably, a mesh-like fabric is integrated into the sealing film 313, which reinforces the sealing film 313 and ensures secure/tear-resistant attachment of the entire adapter piece 3 to the film bag/liner L.

When the adapter piece 3 is used as intended, the preferred cutting portion 32 cuts through the film bag/liner L and makes the product P enclosed by the film bag/liner L accessible.

In this respect, the cutting portion 32 comprises a ring-shaped guiding element 321, a flange portion 322 and a cutting structure 323.

The ring-shaped guiding element 321 defines a passage which is dimensioned such that one end of the conveyor line 7, which will be explained in more detail later, can be inserted through the passage into the opened film bag/liner L for emptying the product P. Furthermore, the ring-shaped guiding element 321 can preferably be inserted into the passage of the ring-shaped connecting element 311 in such a way that it can be displaced along the passage axis or is slidingly mounted on an inner surface of the ring-shaped connecting element 311. In other words, the ring-shaped connecting element 311 of the fixing portion 31 and the ring-shaped guiding element 321 of the cutting portion 32 are guided coaxially to one another.

The flange portion 322 of the cutting portion extends radially outwards from a side of the ring-shaped guiding element 321 facing away from the film bag/liner L as intended with respect to the passage axis of the passage. The flange portion 322 limits a path in which the cutting portion 32 can be displaced with respect to the fixing portion 31 in the direction facing the film bag/liner L, in that the flange portion 322 strikes against an upper end of the ring-shaped connecting element 311 facing away from the film bag/liner 3 as intended during displacement.

The cutting structure 323 is formed on a side of the ring-shaped guiding element 321 facing the film bag/liner L as intended and is configured to cut the outer surface of the film bag/liner L and, if applicable, the sealing film 313 when the ring-shaped guiding element 321 is displaced as intended with respect to the ring-shaped connecting element 311 of the fixing portion 31 in the direction facing the film bag/liner L in such a way that the product P enclosed by the film bag/liner L is accessible. In this respect, the cutting structure 323 is formed in the form of a plurality of prongs, which are formed circumferentially on the edge of the ring-shaped guiding body 321 facing the film bag/liner L as intended. In addition to the prongs, other structures are also conceivable which are suitable for piercing/severing a corresponding film bag/liner L respectively the sealing film 313.

The cutting structure 323 is formed over the entire circumference of the edge or preferably, as illustrated in FIG. 5, only partially. By forming the cutting structure 323 only partially on the edge, only the respective section of the film bag/liner L or the sealing film 313 that comes into contact with the cutting structure 323 formed partially is pierced/separated, while the remaining part of the circumference remains uncut. The cut part of the film bag/liner L or the sealing film 313 thus remains connected to the remaining part of the film bag/liner L. To access the product P, it is sufficient for the user to open the cut part of the film bag/liner L or the sealing film 313.

Partial cutting has the advantage that the cut part remains on the film bag/liner L and cannot be sucked out through the conveyor line 7 when emptying the film bag/liner L.

The cutting portion 32 is an optional component of the adapter piece 3. Alternatively, the adapter piece 3 can also be formed without the cutting portion 32. In this case, the sealing film 313 and/or the film bag/liner L is preferably cut/pierced by means of the conveyor line 7. In this respect, a corresponding cutting element, for example an extendable knife, can preferably be provided on the conveyor line 7 being configured to cut through the sealing film 313 and/or the film bag/liner L.

The tubular film 33 shown in FIG. 5 extends from the ring-shaped connecting element 311 of the fixing portion 31 in the direction facing away from the film bag/liner L as intended. In particular, the tubular film 33 is attached at one end to the side/end of the ring-shaped connecting element 311 facing away from the film bag/liner L as intended. The tubular film 33 is preferably open at the other end.

The tubular film 33 can, for example, be clamped to the ring-shaped connecting element 311 and/or firmly welded and/or glued to it. In particular, a circumferential groove can be formed within the ring-shaped connecting element 311, over which the unattached tubular film 33 can be slipped/pushed and can be fastened by means of a flexible O-ring.

The open end of the tubular film 33 can preferably be attached to the conveyor line 7 on a side of the facing away from the ring-shaped connecting element 311.

FIG. 6 shows a perspective view in which the tubular film 33 of the adapter piece 3 according to the invention is attached to the conveyor line 7 of the emptying device 2 according to the invention.

The conveyor line 7 is configured such that one end of the conveyor line 7 can be inserted by the user through the passage formed by the adapter piece 3 into the opened film bag/liner L containing the product P in order to remove/suck the product P from it.

The conveyor line 7 of the emptying device 2 according to the invention can in particular be connected as intended to a pneumatic conveyor system, which enables the product P to be sucked through the conveyor line 7. In this way, the product P can be fed to a further processing system not shown.

Preferably, the conveyor line 7 comprises a suction pipe 71 and a support portion 72.

The suction tube 71 preferably defines a conveying end, in other words a portion at which the product P leaves the emptying device 2 according to the invention, and an entry end at which the product P, starting from the film bag/liner L, enters the suction tube 71 and thus the emptying device 2 according to the invention. The suction pipe 71 can have a fixed length or be a telescopic suction pipe with a variable length.

In addition, the conveyor line 7 preferably comprises the support portion 72. In the embodiment shown, the support portion 72 is formed circumferentially around the suction tube 71 and enables the open end of the tubular film 33 to be attached to the conveyor line 7.

In the embodiment shown, the support portion 72 comprises two circumferential grooves 721 and 722 in this respect. To secure the tubular film 33, it can be slid over the support portion 72 and secured in one of the two grooves 721 or 722 by means of a flexible O-ring. The handling of the tubular film 33 in connection with the support portion 72 is explained in detail below in connection with the docking/emptying process of the drum F.

In the attached state, the tubular film 33 preferably forms, together with the adapter piece 3, a receiving space sealed off from the external environment, in which the suction tube 71 of the conveyor line 7 is accommodated at least partially. In particular, the inlet end of the suction pipe 71 is accommodated within the receiving space. In this way, any product P stirred up during emptying remains inside the receiving space and cannot escape to the external environment. By forming the receiving space in the interaction of the conveyor line 7, the adapter piece 3 and the tubular film 33, it is therefore not necessary to provide an insulator.

Furthermore, the tubular film 33 can preferably comprise a further detachable receiving space, which is indicated by dashed lines in FIG. 6. In this preferred further separable receiving space, consumables from a previous emptying process, in particular residues of a previous tubular film and/or any O-rings, can preferably be received and subsequently this further separable receiving space can be separated or closed with respect to the remaining receiving space formed by the tubular film 33. Cutting off or sealing can be done by welding or using one or two commercially available cable ties, for example. In particular, the further separable receiving space can be formed by means of a T-shaped protuberance or T-shaped connected side tube, as indicated by the dashed line in FIG. 6. The further separable receiving space is an optional component of the tubular film 33. Alternatively, the separated receiving space can also be formed by a part of the wall of the tubular film 33. In this case, however, the tubular film 33 tapers in the area in which the separated receiving space is formed.

The tubular film 33 is preferably formed by a transparent film. This allows the user to see into the receiving space and/or the other separable/separated receiving space.

FIGS. 7A to J show the intended method for docking the emptying device 2 according to the invention to a drum F containing the product P using the adapter piece 3 according to the invention.

FIG. 7A describes a preferred first step. As illustrated, the drum F is inserted by the user into the holding frame 5 of the emptying device 2 according to the invention and brought into its intended position by the means provided for positioning and fixing. At this point, the docking portion 4 is set to the open state by the movement device 6. A lid of the drum F is opened and removed at this point at the latest, so that the interior of the drum F is accessible.

The user then preferably removes the protective film from the sealing film 313 of the adapter piece 3 according to the invention and preferably inserts it into the interior of the drum F through the passage formed by the docking portion 4. The user then attaches the adapter piece 3 to the outer surface of the film bag/liner L via the adhesive layer provided on the sealing film 313.

FIG. 7 B illustrates a preferred second step and shows a sectional view of the emptying device 2 according to the invention along the X-Z plane. In the preferred second step, the docking portion 4 is lowered using the movement device 6 and moved to the docked state. The rigid plate 41 of the docking portion is pressed tightly onto the upper rim of the drum F.

The air pressure within the inflatable seal of the second sealing device 434 is then increased so that it expands and is pressed against the adjacent ring-shaped connecting element 311 of the adapter piece 3. The ring-shaped connecting element 311 is an example of the sealing portion according to the invention. In this way, a sealing connection is created between the docking portion 4 in the docked state and the adapter piece 3. Thus, the interaction of the docking portion 4 with the adapter piece 3 can form a sealed-off inner space within the drum F.

As illustrated in FIG. 7 C, the user guides/pushes the tubular film 33 of the adapter piece 3 over the suction tube 71 of the conveyor line 7 and attaches it to one of the grooves 721 or 722 of the support portion 72 by means of a flexible O-ring. Preferably, the user attaches the tubular film 33 to the lower groove 722 of the support portion.

As a result, the interaction of the conveyor line 7, the adapter piece 3 and the tubular film 33 now forms the receiving space, which is sealed-off from the external environment and in which the suction tube 71 is accommodated, at least partially. In particular, the inlet end at which the product P enters the suction tube 71 from the film bag/liner L is received.

Furthermore, the pump connector 44 on the docking portion 4 can now be used to reduce the air pressure within the sealed-off inner space 4 so that the flexible outer skin of the film bag/liner L is attracted to the inner wall of the drum F.

In a next step, as illustrated by the arrow in FIG. 7 D, the user presses the cutting portion 32 of the adapter piece 3 downwards with respect to the fixing section 31 in order to cut through the film bag/liner L and, if applicable, the sealing film 313. In this way, the film bag/liner L or the sealing film 313 is cut at least partially and the product P to be emptied is made accessible.

The user then unfolds the cut part of the film bag/liner L and, if applicable, the sealing film 313.

The user carries out the procedure explained in connection with FIG. 7 D while deforming the flexible tubular film 33. This shields the user from the product P. This means that there is no need for an insulator.

The drum F and the foil bag/liner L containing the product P are thus prepared for emptying.

As shown in FIG. 7 E, the user then inserts the conveyor line 7 into the film bag/liner L and empties it.

The user then pulls the conveyor line 7 out of the emptied film bag/liner L again, as shown in FIG. 7 F.

The user further closes and cuts the tubular film 33. In this respect, the user ties the tubular film 33 together in an area between the adapter piece 3 and the support portion 72, preferably below the inlet end of the suction tube 71, and seals the tubular film 33 at this point, for example using a welding device or two commercially available cable ties. Cutting takes place at the sealed point, for example with scissors. This creates two separate recording spaces that are sealed-off from the external environment.

In the next step, the user equalizes the air pressure within the drum F to the ambient pressure again via the pump connector 44, so that the flexible outer skin of the foil bag/liner L detaches from the inner wall of the drum F.

The user then moves the docking portion 4 upwards via the movement device 6 back into the open state.

This results in the state shown in FIG. 7 G.

In this state, the user removes the foil bag/liner L together with the adapter piece 3 attached to it and the remaining cut and sealed part of the tubular 33 from the inside of the drum and disposes of it. The adapter piece 3 according to the invention is therefore preferably non-reusable consumable material.

Since the film bag/liner L, the adapter piece 3 attached to it and the rest of the tubular film 33 form a closed receiving space, the user does not come into contact with the remaining product P inside.

The emptied drum F can then be removed from the holding frame 5.

The other remaining cut of the tubular 33, which is attached to the support portion 72 of the conveyor line 7, remains in place for the time being.

Preferably, a new drum F to be emptied can now be inserted into the holding frame 5, wherein the following steps are required.

FIG. 7 H shows a newly inserted drum F in which the steps described in conjunction with FIGS. 7A and B have already been carried out by the user.

As shown, the user now pushes/guides the tubular film 33 over the remaining cut of the tubular film 33′ from the previous emptying process enclosing the conveyor line 7 and fastens it to the upper groove 721 of the support portion 72 by means of a further flexible O-ring.

The user then detaches the flexible O-ring, which secures the remaining cut of the tubular film 33′ to the lower groove 722 of the support portion 72, and closes it, as shown in FIG. 7 I, within the detachable receiving space of the new tubular film 33. In this respect, the new tubular film 33 is welded at this point, for example, or tied off using one or two standard cable ties. This now severed receiving space can remain on the new tubular film 33 or be severed.

Finally, the user moves the flexible O-ring securing the new tubular film 33 from the upper groove 721 to the lower groove 722 of the support portion 72, as shown in FIG. 7 J, and performs the steps explained in conjunction with FIGS. 7 D to 7 G to empty the drum F.

### LIST OF REFERENCE SIGNS

1 Emptying system
2 Emptying device
3 Adapter piece
31 Fixing portion
311 Ring-shaped connecting element
312 Flange portion
313 Sealing film
32 Cutting portion
321 Ring-shaped guiding element
322 Flange portion
323 Cutting structure
33 Tubular film
4 Docking portion
41 Rigid plate
42 First sealing device
421 Sealing ring
422 Adjustable sealing element
423 Pump connector
43 Flexible connecting element
431 Insertion portion
4311 Ring-shaped portion
4312 Flange
432 Flexible connecting portion
433 Passage portion
434 Second sealing device
4341 Sealing ring
4342 Adjustable sealing element
4343 Pump connector
44 Pump connector
5 Holding frame
6 Movement device
61, 62 Pneumatic cylinder
7 Conveyor line
71 Suction pipe
72 Support portion
721, 722 Groove
F Drum
P Product
L Film bag/liner

1. Emptying device for emptying a container containing a product, comprising:
a docking portion for docking to a rigid container to be emptied, comprising a drum, wherein in the docking portion a passage is formed by an adjustable sealing device, wherein
the passage can be adjusted via the sealing device in such a way that an adapter piece being fixed to a flexible container enclosing the product, comprising a liner or a film bag, inside the rigid container, can be fastened within the passage in such a way that an enclosed inner space defined by the docking portion and the rigid container is sealed off from an external environment.

2. The emptying device according to claim 1, wherein
the sealing device is formed by an inflatable seal surrounding the passage.

3. The emptying device according to claim 1, wherein
a suction device is provided to the docking portion, being configured to lower an ambient pressure within the enclosed inner space in such a way that the flexible container abuts against an inner wall of the rigid container at least partially.

4. The emptying device according to claim 1, wherein
the emptying device further comprises a conveying line being insertable through the passage of the docking portion and through the adapter piece into the flexible container enclosing the product in order to remove the product.

5. The emptying device according claim 1, wherein
the docking portion comprises a rigid plate attachable to an opening of the rigid container, a flexible connecting member and a passage portion forming the passage and supporting the sealing device, wherein
the rigid plate and the passage portion are connected via the flexible connecting element in such a way that deviations in a distance and/or a relative positioning between the passage portion forming the passage and the adapter piece fixed to the flexible container can be compensated for during fastening by deformation of the flexible connecting element.

6. The emptying device according to claim 5, wherein
the rigid plate forms a further passage to which a further adjustable sealing device is provided, wherein
the further passage can be adjusted via the further sealing device in such a way that the flexible connecting element can be fastened within the further passage for connection to the rigid plate.

7. The emptying device according to claim 1, wherein
the emptying device comprises a holding frame wherein
a movement device is provided to the holding frame, being configured to move the docking portion along a longitudinal axis of the rigid container relative to the rigid container in such a way that the docking portion is in an open state or a docked state.

8. Adapter piece to be fixed to a flexible container enclosing a product, comprising:
a fixing portion being fixable to a flexible container enclosing the product, comprising a liner or a film bag, and
a sealing portion being configured to interact with an adjustable sealing device of a docking portion of an emptying device in such a way that an enclosed/sealed connection between the sealing portion and the sealing device can be established.

9. The adapter piece according to claim 8, further comprising an adhesive layer to be fixed to an outer surface of the flexible container.

10. The adapter piece according to claim 9, wherein
the adhesive layer is formed on a sealing film attached to the fixing portion projecting radially outwards beyond the fixing portion.

11. The adapter piece according to claim 8, wherein
the adapter piece comprises a cutting portion being configured to cut open the flexible container at least partially in order to make an interior of the flexible container accessible for removing the product.

12. The adapter piece according to claim 10, wherein
the fixing portion defines a passage being dimensioned such that the cutting portion can be inserted into the passage of the fixing portion and is guided within the passage.

13. The adapter piece according to claim 8, wherein
a tubular film is fixed to the adapter piece, which can be guided over a conveyor line being insertable through the adapter piece into the flexible container containing the product in order to remove the product and can be attached to a support portion formed on the conveyor line.

14. An emptying system for emptying a container containing a product comprising:
the emptying device of claim 1,
wherein the adapter piece comprises:
a fixing portion being fixable to the flexible container enclosing the product, and
a sealing portion being configured to interact with the adjustable sealing device of the docking portion of the emptying device in such a way that an enclosed/sealed connection between the sealing portion and the sealing device can be established.

15. A method of docking an emptying device to a container containing a product, comprising the following steps:
Inserting an adapter piece into an interior of a rigid container containing a product to be emptied, comprising a drum;
Fixing the adapter piece to a flexible container enclosing the product, comprising a liner or a film bag, within the interior of the rigid container,
Docking a docking portion to the rigid container to be emptied, wherein a passage with an adjustable sealing device is formed in the docking portion, and
Adjusting the sealing device in such a way that the adapter piece can be fixed within the passage in such a way that an enclosed inner space defined by the docking portion and the rigid container is sealed off from an external environment.
